(19) United States
(12) Patent Application Publication
(10) Pub. No.: US 2015/0027298 A1
(43) Pub. Date: Jan. 29, 2015

(54) Color Coded Music

(71) Applicant: Mary Marcel Simpson, Brookshire, TX (US)

(72) Inventor: Mary Marcel Simpson, Brookshire, TX (US)

(21) Appl. No.: 14/341,749

(22) Filed: Jul. 25, 2014

Related U.S. Application Data
(60) Provisional application No. 61/859,623, filed on Jul. 29, 2013.

(51) Int. Cl. G10G 1/02

(52) U.S. Cl. CPC G10G 1/02
USPC 84/478

(57) ABSTRACT

An improved method of scoring music comprises the steps of: color coding the eight groups of keys on a piano keyboard with eight different colors; labeling each key on the piano keyboard with a colored lettered sticker; representing each key in a unique position on a four-line, three-space staff, colored to match the color group of the keyboard; lettering identically the four lines and three spaces of each colored staff from bottom to top on the lines and spaces; and in each octave, labeling each of the five black keys in sequence as H, I, K, and L, and noting them on a musical score with a diamond-shaped note.

### CROSS-REFERENCE TO RELATED APPLICATIONS

This patent application claims the benefit of provisional patent application Ser. No. 61/859,623, filed Jul. 29, 2013.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### BACKGROUND OF THE INVENTION

(1) Field of the Invention

The invention relates to musical staffs and notation systems.

(2) Description of Related Art (including information disclosed under 37 CFR 1.97 and 1.98)

There is much confusion for people new to playing the piano. Three obstacles are particularly difficult to overcome in learning to play the instrument. The first problem is that the piano keyboard is a sea of 88 unmarked black and white keys. While there is a repeating sequence among the white keys A, B, C, D, E, F and G across the keyboard, and a distinguishing feature of the 36 black keys being divided into two noticeable groups—one with two black keys and the other with three—no distinguishing breaks exist among the A-G groups of keys from one to the next. (See FIG. 1.) An analogy to this would be having to type on an unmarked computer keyboard or dialing calls on an unmarked phone, which would be confusing for most people.

A second significant problem involves learning the convention of traditional sheet music, which requires reading and playing music from the unmarked Grand Staff comprised of the Bass and Treble Staffs. The Treble Staff is positioned at the top of the Grand Staff while the Bass Staff is on the bottom. Each of these staffs contains five lines and four spaces and other than a Treble Clef or Bass Clef, they appear identical. The lettering of the lines and spaces on the Treble and Bass Staffs do not correlate with each other and the notes displayed are never labeled. Notes on the Treble Staff are played with the right hand and from the bottom to the top represent the piano keys, E, F, G, A, B, C, D, E and F. (Underlined notes fall on lines; notes not underlined fall on spaces). The Bass Staff displays notes to be played with the left hand, and which represent a different sequence from bottom to top, G, A, B, C, D, E, F, G and A. (See FIG. 2.) To complicate the matter, there are also ledger lines for capturing the high and low notes that appear below the Bass Staff, in between the Bass and Treble Staffs, and above the Treble staff. (See FIG. 3.) Having to play a separate music notation system for each hand simultaneously is bewildering to mast people. The challenge not only involves deciphering music written on the two different staffs and accompanying ledger lines, but then immediately being able to correlate every note to its correct location on a keyboard comprised of the 88 unmarked keys. To master the Bass and Treble Staffs people have relied on repetitious phrases to help them to remember the line and space designations. The Treble Staff lines from bottom to top are typically associated with “Every Good Boy Does Fine,” while “F-A-C-E” spells out the lettering of the spaces. Popular phrases to help remember the lettering of the Bass Staff from bottom to top are “Good Boys Deserve Fudge Always” for the lines and “All Cows Eat Grass” to help recall how the spaces are lettered. The “floating” notes—those high and low notes which appear on and around ledger lines—just have to be remembered. If not played frequently, they are particularly challenging to learn.

A third significant problem with learning piano is the black keys. Each black key has two names on the keyboard and is represented two different ways in traditional sheet music—as a sharp or flat note. For example, the black keys which fall between all A and B white keys on the keyboard represent both A sharp and B flat. (See FIG. 4.) To indicate when black keys (sharps and flats) are played in traditional sheet music, the sharp or flat symbol appears in the first measure only of each line and is specifically positioned on the particular line or space of the note being modified. Furthermore, sharps and flats throughout a piece of music also have the potential of becoming modified in subsequent measures by the natural symbol (See FIG. 5), which will appear beside the note when it is to be played normally—i.e., the note is played as a white key. It must then be remembered to resume playing the particular note as originally Assigned—as a sharp or flat—in the remaining measures unless, of course, the natural symbol reoccurs. If a black key (sharp or flat) is only to be played in isolated cases and not throughout a piece of music, the appropriate sharp or flat symbol appears beside the note. Then one must remember to resume playing the note normally in subsequent measures unless the sharp or flat notation again appears next to it. (See FIG. 6) Keeping such rules straight while playing is confusing and can become overly frustrating. Many people with a passable understanding of music avoid playing music pieces that contain more than one sharp or flat.

U.S. Pat. No. 7,439,438, which is incorporated herein by this reference, states in the abstract that it is an “improved musical notation system” that “replaces the Grand Staff's system of lines and spaces with a system of ‘pitch stripes’ of two colors arranged in the same pattern as the black and white keys of the standard piano keyboard. However, the notation system disclosed in this patent limits itself to only TWO colors.

In light of the foregoing, a need remains for an improved musical notation system that 1) minimizes the confusion in traditional music with playing sharps and flats, and 2) clarifies when the black keys on a piano are supposed to be played.

### BRIEF SUMMARY OF THE INVENTION

An improved method of scoring music comprises the steps of: color coding the eight groups of keys on a piano keyboard with eight different colors; labeling each key on the piano keyboard with a colored lettered sticker; representing each key in a unique position on a four-line, three-space staff, colored to match the color group of the keyboard; lettering identically the four lines and three spaces of each colored staff from bottom to top on the lines and spaces; and in each octave, labeling each of the five black keys in sequence as H, I, J, K, and L, and noting them on a musical score with a diamond-shaped note.

Color Coded Music (“CCM”) solves the problems identified with traditional piano music. First, CCM puts the white and black keys of the piano into distinguishable lettered color groups by using eight different sets of colored lettered stickers to distinguish each of the eight groups of keys on an 88-key piano keyboard. Beginning on the left end and moving from left to right across the keyboard, seven of these groups each contain 12 keys—seven white keys and five black keys. The eighth group of keys on the far right side of the keyboard contains only three white keys and one black key. Second, CCM standardizes the staffs, and drops the clef designations, Each color group of keys is represented on CCM sheet music by a same colored staff comprised of four lines and three spaces. Each colored staff is lettered identically from bottom to top on the lines and spaces. Third, CCM introduces new diamond shaped notes to distinguish the five black keys, and renames them. Continuing with the alphabet, CCM designates the black keys as H, I, K or L. The white keys, A, B, C, D, E, F and G retain their original letter designation and oval shape as in traditional music.

### BRIEF DESCRIPTION OF THE SEVERAL VIEWS OF THE DRAWINGS

The novel features characteristic of the invention are set forth in the appended claims. However, the invention itself, as well as a preferred mode of use, and further objectives and advantages thereof, will best be understood by reference to the following detailed description, when read in conjunction with the accompanying drawings, in which the left-most significant digit(s) in the reference numerals denote(s) the first figure in which the respective reference numerals appear.

FIG. 1 is a perspective view of prior art of an 88 black and white key piano keyboard.

FIG. 2 is a prior art schematic diagram of the Grand Staff.

FIG. 3 is a prior art schematic diagram of the Grand Staff showing placement of notes above, between and below Treble and Bass Staffs.

FIG. 4 is a prior art schematic diagram of the traditional black and white 88-key piano keyboard with the white keys and black keys marked with their note designation and showing a prior art schematic diagram of the flat and sharp symbols used in traditional music.

FIG. 5 is a prior art schematic diagram of the natural symbol used in a traditional music.

FIG. 6 is a prior art schematic diagram showing a music piece with sharp and natural symbols appearing in different positions on the Treble and Bass Staffs. Sharps for this key are only in the first measure of each line . . . note the three sharps grouped together on the bass and treble staffs. Other sharps are added in some measures.

FIG. 7 is schematic diagram of an illustrative embodiment of the present invention showing the layout of color groups and placement of “white Key” stickers on a color coded piano keyboard.

FIG. 8 is a schematic diagram of an illustrative embodiment of the present invention showing the completed sticker layout on the color coded keyboard with black keys marked with new names H-I-J-K-L.

FIG. 9 is a schematic diagram of an illustrative embodiment of the present invention showing complete color coded staffs with traditional oval notes for every white key.

FIG. 10 is a schematic diagram of an illustrative embodiment of the present invention showing a line of color coded music with diamond shaped notes for the black keys and a partial yellow staff.

FIG. 11 is a schematic diagram of an illustrative embodiment of the present invention showing complete color coded staffs with new diamond shaped notes for every black key.

FIG. 12 is a schematic diagram of an illustrative embodiment of the present invention showing a line of color coded music compared to a prior art schematic diagram of the same line of music represented in the traditional sheet music format.

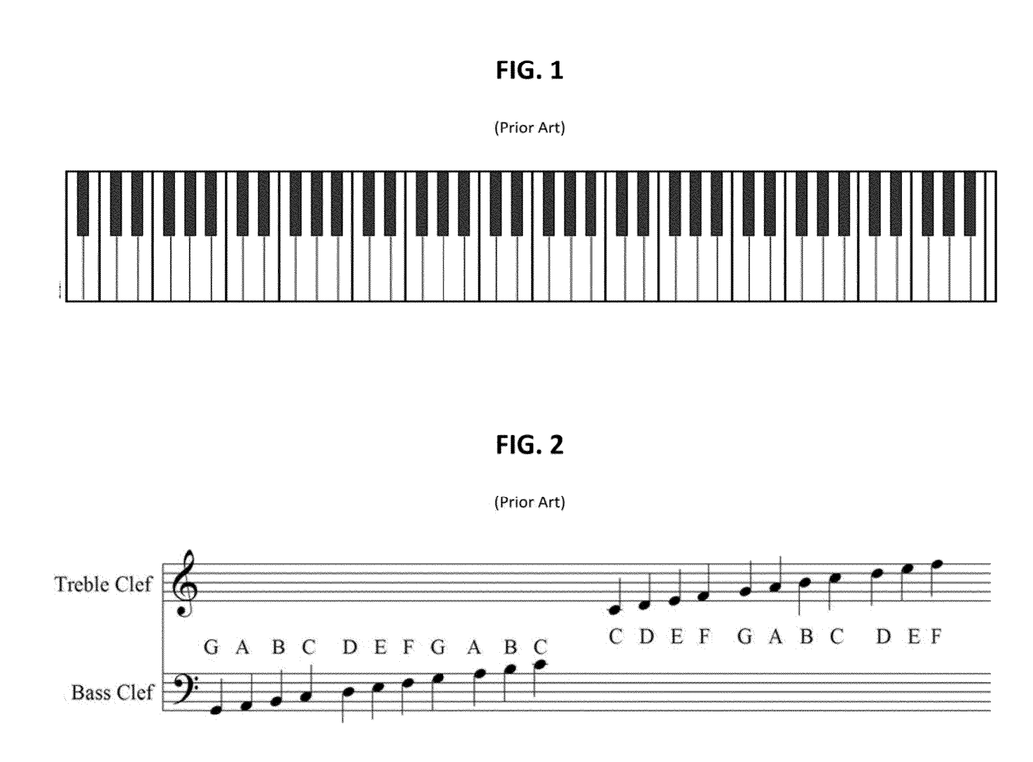

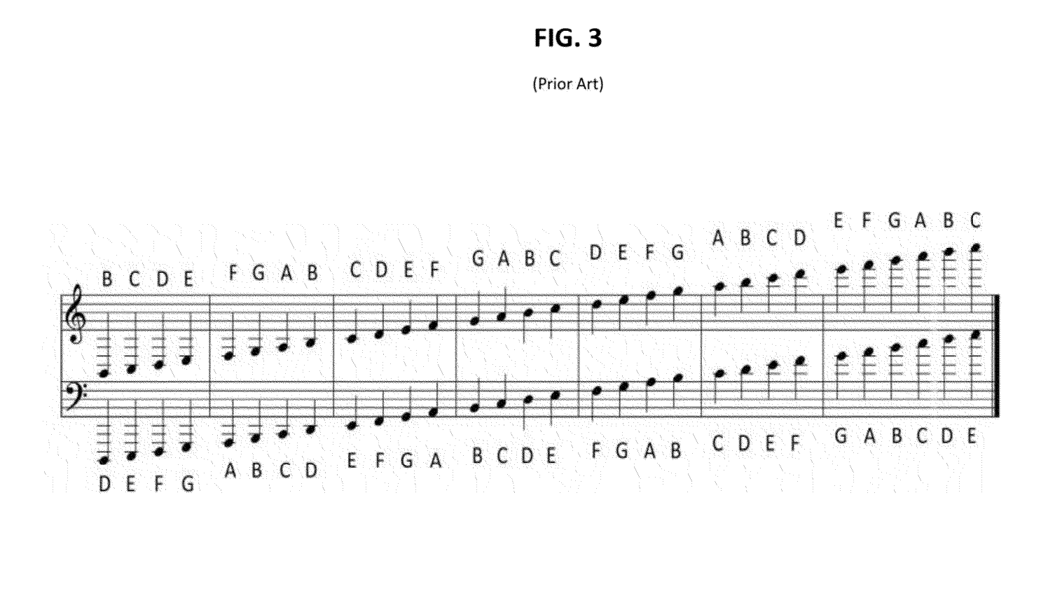

### DETAILED DESCRIPTION OF THE INVENTION

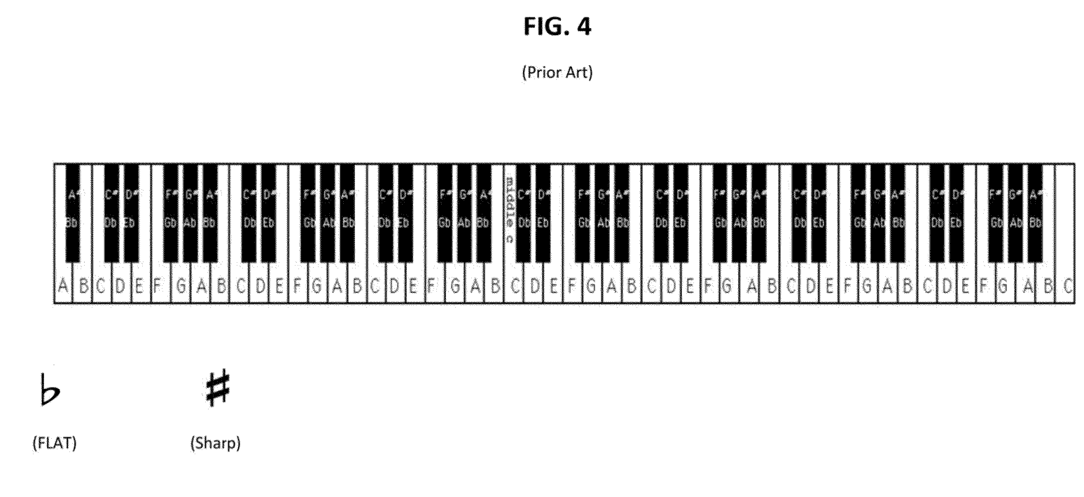

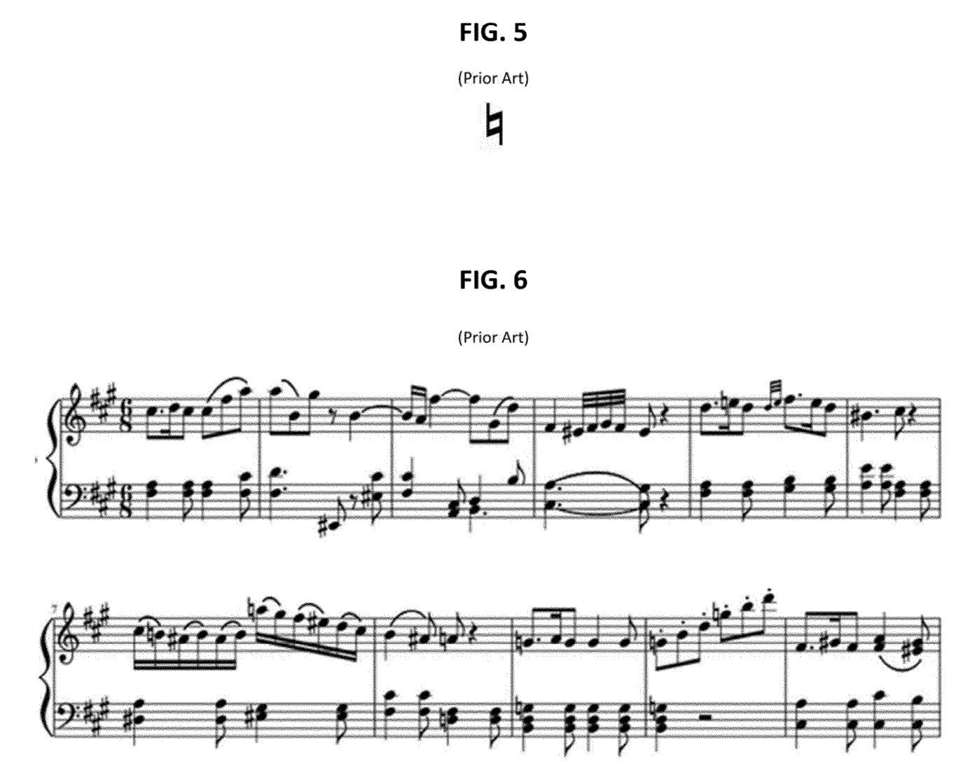

The full sized piano keyboard comes equipped with 52 white keys and 36 black keys. Beginning at the first white key on the far left side of the keyboard and moving to the right, there are eight groups of keys—seven of these contain seven white keys for the notes A, B, C, D, E, F, G, and five black keys for the sharp and flat tones of A sharp/B flat, C sharp/D flat, D sharp/E flat. F sharp/G flat, and G sharp/A flat. The last or eighth group contains only three white keys for the notes A, B, and C, and one black key for A sharp/B flat. (See FIG. 4).

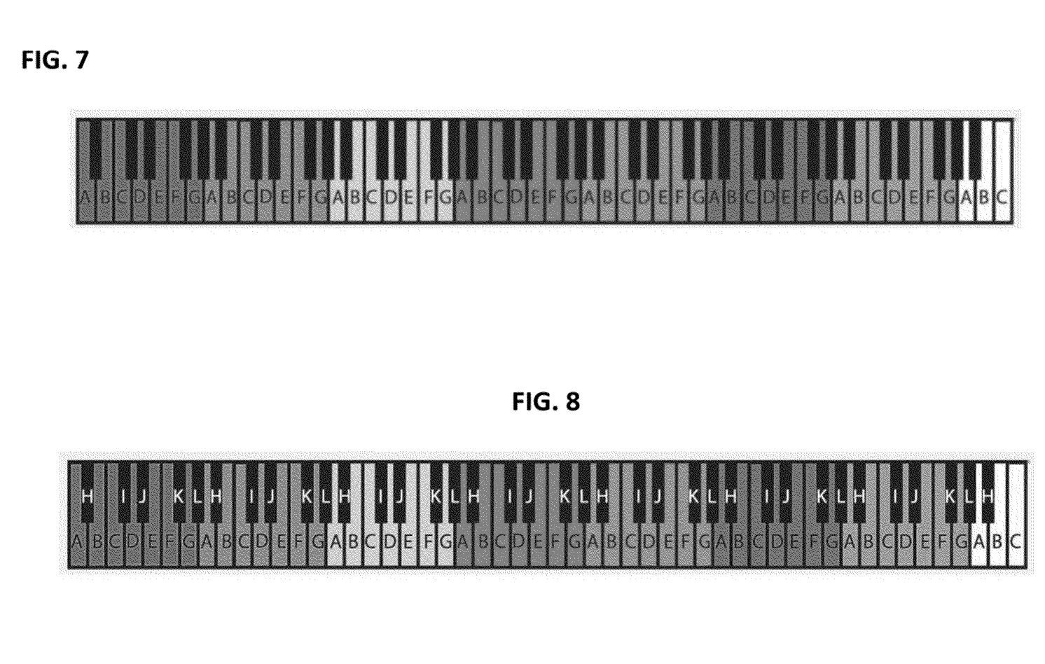

CCM differentiates each of the eight groups of keys by assigning a different color to each group. From left to right, the key group colors are red, orange, yellow, green, blue, purple, pink and white. For the full 88-key keyboard, colored lettered stickers are applied to the 52 white keys beginning with the red A sticker for the A note placed on the far left white key and then following the pattern shown in FIG. 7. Unlike traditional music in which each black key is represented by both a sharp and flat note, CCM uniquely identifies the black keys as notes H, I, J, K, and L. In similar fashion, the 36 black keys are labeled with colored lettered stickers H, I, J, K, and L. The H-I-J-K-L pattern repeats in each of the seven full groups of keys with the eighth group's single black key labeled as H. The black key between the A and B white keys is H, which replaces A sharp/B flat. Continuing in this pattern, the black key between the C and D white keys is I and replaces C sharp/D flat; the black key between the D and E white keys is J and replaces D sharp/E flat; the black key between the F and G whites keys is K and replaces F sharp/G flat; and the black key between the G and A white keys is L, which replaces G sharp/A flat. (See FIG. 8.) A future optimal keyboard design would be for all of the keys to be fully colored according to the CCM color group pattern and the associated letters permanently marked on the keys.

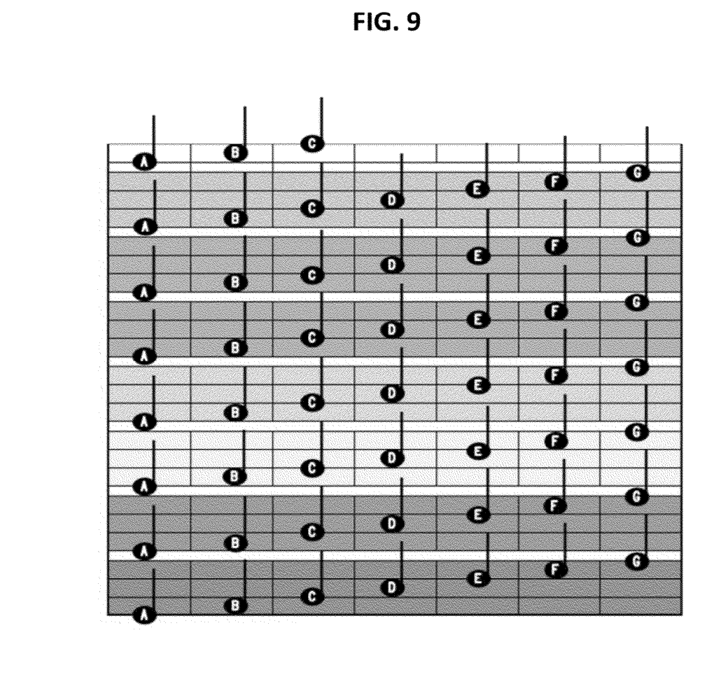

CCM sheet music assigns a separate colored staff to each color group of keys on the piano keyboard. Each CCM staff uniformly contains only 4 lines and 3 spaces (versus 5 lines/4 spaces in traditional piano sheet music) for displaying all notes in identical patterns regardless of the particular color. Every CCM staff begins with A on the first (bottom) line and ends with G on the last (top) line with the other notes falling on the spaces and lines in between. (See FIG. 9) With uniformity in the color coded staffs there is no more struggling with the differing note patterns of the Treble and Bass Staffs.

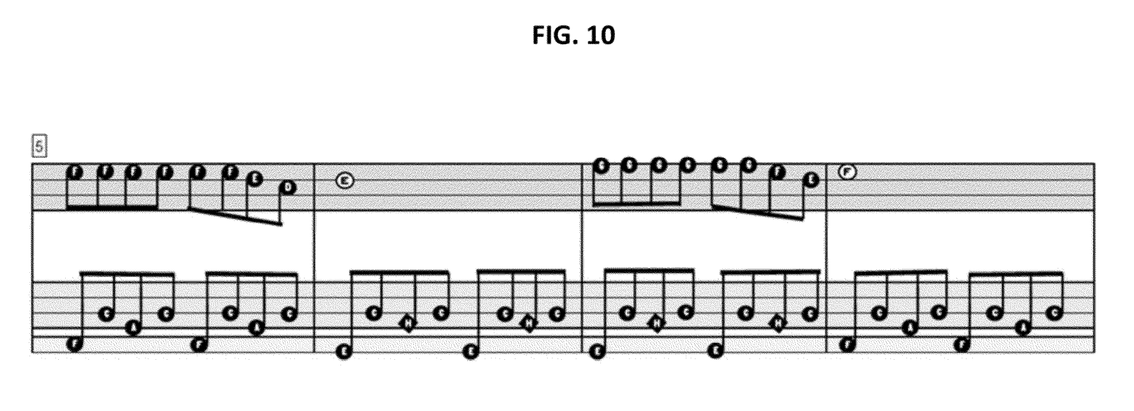

The colored staffs in CCM sheet music are displayed from bottom to top beginning with the red staff corresponding to the red group of keys on the far left side of the keyboard. The red staff is presented as the bottom staff followed successively by the orange, yellow, green, blue, purple, and pink staffs and finally with the white staff at the top. The colored staffs are separated by a thin white line space. A large white space divides the staffs for the purpose of displaying music to be played by the left hand (below the large white space) and the music to be played by the right hand (above the large white space). If a particular song contains lyrics, the words will appear in this large white space between the top and bottom staffs as in traditional music. Most piano music typically ranges within the yellow, green, and blue staffs. For the sake of clarity and to save space, only colored staffs to cover the range of notes in a piece of music appear in CCM sheet music. When necessary to display a group of higher or lower notes in a particular piece of music (floating notes in traditional sheet music), CCM displays only partial colored staffs to clarify location on the keyboard of those notes. (See FIG. 10.) This is an important and helpful feature of CCM sheet music—there are no ledger lines or floating notes. Every note has a unique position on a colored staff, which readily correlates to its correct location on the keyboard. CCM further ensures all notes are distinguished by capital letters to identify the notes they signify.

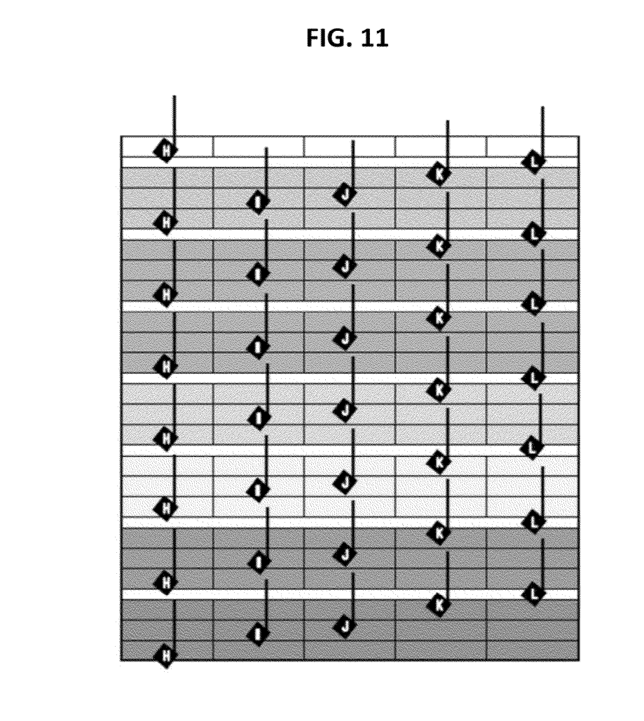

CCM overcomes the sharp/flat problem by assigning unique note designations to the black keys. As previously explained, CCM renames the black keys as H, I, J, K, or L. It also introduces the diamond shaped note symbol (vs. oval shape) to clearly indicate when black keys H, I, J, K, and L are played. (See FIG. 11.) This is another important feature of CCM in that the black keys are uniquely distinguished to eliminate the prevalent confusion in traditional music with playing sharps and flats. On the CCM staffs, diamond shaped notes are placed on the lines and spaces corresponding to the notes of the white keys between which they fall, starting at the bottom with H and ending at the top with L. Exact placement of the diamond shaped notes on the colored staff is as follows. The black key H, between white keys A and B, is positioned over the A line and fills the B space with the top point of the diamond just touching the C line. The black key I, between white keys C and D, is positioned over the C line and fills the D space with the top point of the diamond just touching the E line. The black key J, between white keys D and E, fills the D space and is positioned over the E line with the bottom point of the diamond just touching the C line. Similarly, the black key K, between white keys F and G, fills the F space and is positioned over the G line with the bottom point of the diamond just touching the E line. The L note appears between the G and A lines in the white space separating the colored staffs. As previously highlighted, all notes in CCM sheet music, oval or diamond, are labeled with the associated capital letters that positively correlate them with specific locations on the keyboard.

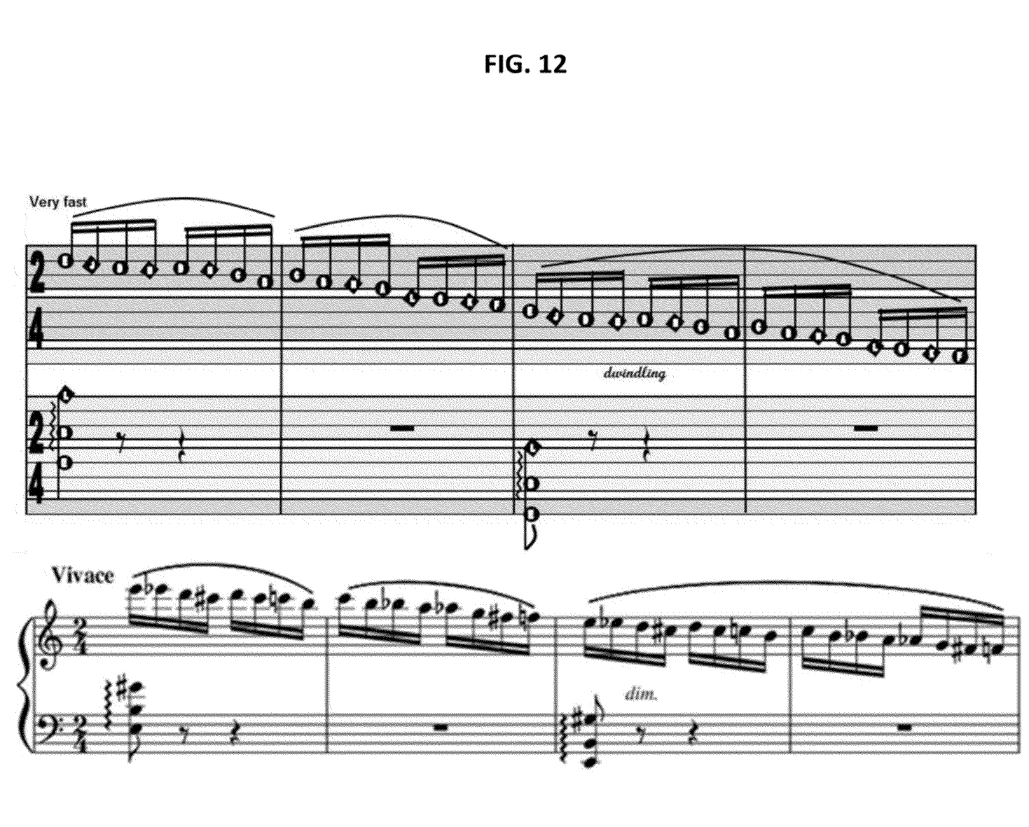

A principal advantage of CCM is that it eliminates uncertainty about whether notes are “sharp,” “flat,” or “natural.” The burdensome task of keeping track on when to play a sharp or a flat or when to return back to a natural note is eliminated. Each black key is now easily identified and accounted for. If a white key is to be played instead of a black key, it merely shows up in the music as an oval shaped note. There is no longer a need for sharp, flat, or natural symbols. If a piece of CCM sheet music contains no diamond shape notes, then no black keys are played. Since CCM consistently enables rapid identification of notes and their corresponding location on a labeled keyboard, the music student is less encumbered finding keys and can right away begin working on proper technique and tempo for the instrument. There is no confusion on what to play and more focus on how to play. (See FIG. 12)

While clefs, sharps, flats, and natural symbols are omitted and unnecessary for reading and playing music using the CCM method, it is important to note that the remaining traditional sheet music symbology is unchanged. For example, CCM follows traditional rules for counting, time signatures, measures, and the beats for the various notes and rests, etc.

I claim:

1. An improved method of scoring music, comprising the steps of:
a. color coding the eight groups of keys on a piano keyboard with eight different colors;
b. labeling each key on the piano keyboard with a colored lettered sticker;
c. representing each key in a unique position on a four-line, three-space staff, colored to match the color group of the keyboard;
d. lettering identically the four lines and three spaces of each colored staff from bottom to top on the lines and spaces; and
e. in each octave, labeling each of the five black keys in sequence as H, I, J, K, and L, and noting them on a musical score with a diamond-shaped note.

2. The method of claim 1, wherein the colors used to color code the eight groups of keys on the piano are red, orange, yellow, green, blue, purple, pink, and white.
